(19) United States
(12) Patent Application Publication
(10) Pub. No.: US 2015/0263589 A1
(43) Pub. Date: Sep. 17, 2015

(54) Rail Barrel Direct Energy Transferor Piezoelectricity (RBDETP)

(71) Applicant: Varnell M. Castor, Chelsea, MA (US)

(72) Inventor: Varnell M. Castor, Chelsea, MA (US)

(21) Appl. No.: 14/645,013

(22) Filed: Mar. 11, 2015

Related U.S. Application Data
(60) Provisional application No. 61/950,889, filed on Mar. 11, 2014.

(51) Int. Cl. H02K 7/18; H02J 7/00

(52) U.S. Cl. CPC H02K 7/1892; H02J 7/0068

(57) ABSTRACT

Disclosed is a compact portable compressed air energy storage (CAES) system that works with renewable energy sources and utilizes batteries to store energies instead of using turbine generators to store energies like traditional CAES systems. The compressed air source can be utilized to apply kinetic pressure to a series of linear or magnetic induction generators to produce energy and store the electricity for end users, enabling the device to function as a portable generator and power station. Its design allows it to apply a fraction of the accumulated energy to generate compressed air with sufficient pressure to trigger a series of novel generators. The isothermic portable design, instead of traditional diabatic design with heat exhausts, makes it appropriate for multiple applications, including handheld power, home power, regional power, and EV-to-grid.

### RELATED APPLICATION

This application claims the benefit of priority to U.S. Provisional Patent Application Ser. No. 61/950,889, filed Mar. 11, 2014, the contents of which are hereby incorporated by reference.

### FIELD OF THE INVENTION

The present invention relates to the field of energy production, conservation, and transference. Specifically, a portable isothermal compressed air energy storage (CAES) generator system is proposed that allows for a CAES chamber with connected motorized pump to work in conjunction with renewable energy input sources and a series of interconnecting novel generative outputs to generate excess energies during peak hours and store electrical energy into one of the multiple batteries that can be interconnected thereby allowing electrical energy to be stored and redirected whether during peak or off-peak periods. The present invention does away with traditional diabatic storage-based CAES heat exhausts and intercooling during the compression process since CAES chambers simply allow the high ratio of gas within the volume of the compression chamber to heat up during compression, and likewise to cool down during expansion. This is attractive for multiple applications, including EV-to-Grid, since the energy losses associated with heat transfer are avoided.

### BACKGROUND OF THE INVENTION

No identified prior art discloses a portable compressed air energy storage (CAES) system comprising a portable auxiliary power source, an operational battery (Battery 1), a battery to store generative energy (Battery 2), and an air (pneumatic gas) drive system that includes a series of linear generators at distal ends; wherein a drive shaft or bridge bar that bridges or interconnects two parallel side track rods is implemented as a kinetic force unit; wherein the two parallel side track rods are driven up and down the drive path or barrel by interconnected pneumatic pistons that are adjacent to one another, wherein these pneumatic pistons apply force to parallel side track rods that traverse up and down the distal ends of the barrel; wherein the drive shaft or bridge bar that interconnects both parallel side track rods engages with the linear generators when traversing back and forth on a timing sequence because of manual or automatic relay switches that work with relays and control modules and valves to regulate the air or gas output stored in the air compressor chamber that drives the pneumatic pistons that are located at both distal ends of the drive system or barrel; wherein the drive shaft or bridge bar that interconnects the two side tracks engages the generators in order to transfer motion in the form of kinetic energy to the respective series of linear generators; wherein the motion of the drive shaft or bridge bar from one distal end to the other distal end simultaneously applies kinetic force to not only the series of linear generators but also applies kinetic force to distal ended manual relay switches to trigger the movement of pneumatic pistons; wherein pneumatic pistons that are perpendicular to the series of linear generators apply force to the side track rods that interconnect with the pneumatic pistons that provide pneumatic-induced motion to the interconnected drive shaft or bridge bar that interconnects both side track rods that apply kinetic force to the respective generators; wherein a compressed air source operated by battery 1 or a first electrical energy storage unit receiving energy from a portable auxiliary power source, namely a mounted solar panel or wind generator or power grid, supplies operational energy to the motorized pump of the air compressor and relay or control module that works with distal ended relay switches that regulate the movement and direction of the pneumatic pistons in order to push the drive shaft or bridge bar back and forth until either the volume of the compressed air chamber is low, power sources are depleted or the electrical energy storage units are full to capacity, the device is turned off or a killswitch command is sent from battery sensors to the control module to cease generative energy operations; wherein linear generators, also known as linear magnetic induction units, are positioned along the distal ends of the parallel or extended side track rods and the respective linear generator such that upon impact with the front frames of the drive shaft or bridge bar, said magnetic induction units shall generate electricity, which is converted by a transformer, then transferred and stored to battery 2 or electrical energy storage unit 2.

In this and many other respects, the rail barrel departs from the conventional concepts and designs of the prior, traditional, or existing compressed air energy storage (CAES) systems.

### SUMMARY OF THE INVENTION

The rail barrel direct energy transferor piezoelectricity is a compressed air energy storage (CAES) electricity production apparatus with storage capability, which can be used in a microgrid configuration, that includes a rail barrel or modified drive system setting within which a drive shaft or bridge bar traverses back and forth in order to transfer kinetic linear energy to a series of linear generators located at distal ends of said rail barrel. The distal ends of the drive system or rail barrel is outfitted with pneumatic pistons that are interconnected with two parallel side track rods that use a drive shaft or bridge bar as a bridge. The pneumatic pistons are being supplied compressed air from an air compressor source or chamber, which pushes parallel side track rods which in turn push the drive shaft or bridge bar into linear generators.

An object of the invention is to provide a modified drive system or rail barrel that includes linear generators at distal ends, which are sequentially transferred linear energy from a drive shaft or bridge bar from inside of the rail barrel.

Another object of the invention is to provide a force application bar that interconnects the side track rods that are supplied kinetic energy by the pneumatic pistons positioned at distal ends to apply kinetic force to a series of linear generators positioned at distal ends.

A further object of the invention is to provide pneumatic pistons adjacent each distal end, which are interconnected with parallel side tracks to generate pneumatic movement.

An additional object of the invention is to supply an auxiliary power source, namely a mounted solar panel and/or wind generator, to operate the compressed air source for remote or portable power station purposes. The compressed air source will supply pneumatic force to the pneumatic pistons in order to aid the springs in pushing the drive shaft or bridge bar towards both linear generators and manual action controllers that are located on distal ends of the barrel. The drive shaft or bridge bar engages with the manual action controllers, which sends a command to the relay or control module to regulate the directional flow of compressed gas at a time towards one pair of distal-ended pneumatic pistons or the other. This traverse motion imparts newly added kinetic pressure to the series of linear generators positioned at each distal end.

A further object of the invention is to provide a series of magnetic induction generators, instead of the turbine-only generators that existing CAES systems traditionally adopt, for energy production purposes. Force is applied to the linear magnetic induction generators by the traversing motion of the drive shaft or bridge bar; wherein the bar applies force to the magnet set atop a compressed spring that facilitates motion between the magnet's magnetic field and conductive coil to emit an AC electrical output. Transformers are used in conjunction with the magnetic induction generators to convert AC to DC power. The linear generators work in conjunction with the system's auxiliary power, namely a mounted solar panel or wind generator or power grid.

A further object of the invention is to provide two electrical energy storage units that store electricity. The first electrical energy storage unit stores electricity generated from the auxiliary power source and supplies it to the motorized pump of the compressed air source; wherein the second electrical energy storage unit stores electricity generated from the linear generators and supplies end user power. The first and second electrical energy storage units can be interconnected.

These together with additional objects, features and advantages of the portable energy generator and storage design will be readily apparent to those of ordinary skill in the art of portable compressed air energy storage (CAES) systems upon reading the following detailed description of illustrative embodiments of the portable air driven generator and storage system when taken in conjunction with the accompanying drawings.

In this respect, before explaining the current embodiments of the portable air driven generator and storage system in detail, it is to be understood that the portable air driven generator and storage system is not limited in its applications to the details of construction and arrangements of the components set forth in the following description or illustration. Those skilled in the art of portable compressed air energy storage (CAES) systems will appreciate that the concept of this disclosure may be readily utilized as a basis for the design of other structures, methods, and systems for carrying out the several purposes of the portable air driven generator and storage system.

It is therefore important that the claims be regarded as including such equivalent constructions insofar as they do not depart from the spirit and scope of the microgrid portable air driven generator and storage system. It is also to be understood that the phraseology and terminology employed herein are for purposes of description and should not be regarded as limiting.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the invention.

FIG. 1 illustrates one example of the energy system's operational sequence of events.

FIG. 2 illustrates a cross-sectional view of a novel linear or magnetic induction generator, detailing the generator's configuration, applicable componentry and usage of a transformer therein.

FIG. 3 illustrates a process of magnetic induction, emphasizing the use of motion of a magnet inside an inductive coil to promote AC discharge.

FIG. 4 illustrates a cross-sectional view of an energy system's compact cartridge design, detailing the invention's portable configuration and applicable componentry as well as illustrating a view of each distal end inside of the rail barrel and depicting the configuration and arrangement of the generator, the pneumatic pistons, and the magnetic induction generators therein.

FIG. 5 illustrates the distal end of a rail barrel with detail as to the construction of one of the magnetic induction generators using the optional second spring.

FIG. 6 illustrates an energy system within a cartridge setting and the energy system's use of components that regulate compressed air or gas such as relay and valves to influence the pneumatic componentry of a series of aligned cartridges.

FIG. 7 illustrates a cross-sectional view of the adaptability of an energy system into mobile stations, namely a compact electric vehicle, as it illustrates the EV-to-Grid application and usage of an auxiliary power source, namely a solar panel, view of the system, and detailing the compact or portable configuration of the applicable componentry therein.

FIG. 8 illustrates a cross-sectional view of the adaptability of an energy system into mobile stations, namely a heavy duty truck or electric vehicle, as it illustrates the EV-to-Grid application and usage of an auxiliary power source, namely a solar panel, view of the system, and detailing the compact or portable configuration of the applicable componentry therein.

FIG. 9 illustrates a cross-sectional view of the adaptability of an energy system into a single house or building to provide power as it illustrates the auxiliary power, namely a mounted solar panel, view of the system, and detailing the compact or portable configuration of the applicable componentry therein.

FIG. 10 illustrates a cross-sectional view of the adaptability of an energy system into two houses to provide utility or regional power as it illustrates the auxiliary power, namely a mounted solar panel, view of the system, and detailing the compact or portable configuration of the applicable componentry therein and its wired communication with a control house and applicable electrical grid.

FIG. 11 illustrates the invention design utilizing renewable wind technology, which requires constant motion to direct wind power into valves to facilitate moment of inertia of the wind generator; whereas, electrical production as an auxiliary power source and as a secondary power source is permitted to facilitate both the generative and storage operations of the invention. Whether stationary or incorporated into a moving vehicle, wind power can work in conjunction with an air admittance valve and the compressor motor in converting air-to-pressurized gas and then storing it in the air chamber for systemic operations.

FIG. 12 illustrates a cross-sectional view of the adaptability of a CAES design as a portable handheld energy system, as it illustrates the auxiliary power, namely a mounted solar panel, view of the battery system, generators, compressed air system and detailing of the configuration of the applicable componentry therein.

### DETAILED DESCRIPTION OF THE INVENTION

The following detailed description is merely exemplary in nature and is not intended to limit the scope of the invention. As used herein, the word “exemplary” or “illustrative” means “serving as an example, instance, or illustration.” Any implementation described herein as “exemplary” or “illustrative” is not to be construed as preferred or advantageous over other implementations. All of the implementations described below are exemplary implementations provided to enable persons skilled in the art of compressed air energy storage (CAES) systems to practice the disclosure and are not intended to limit the scope of the appended claims. Furthermore, there is no intention to be bound by any expressed or implied theory presented in the preceding technical field, background, brief summary or the following detailed description.

### KEY TO NUMERICAL REFERENCES BELOW OR IN THE DRAWINGS

100—Invention—Rail Barrel Direct Energy Transferor Piezoelectricity
109—Auxiliary power source
101—Housing or Rail Barrel
102—Undefined length
103—Undefined internal length or width or depth
104—Extended side track rods
105—Inner surface
106—Drive shaft or bridge bar
   118—Housing of the drive shaft or bridge bar
107—Distal end (Invention)
   128—Inverter
   130—First electrical energy storage unit—capacitor or battery (Air source)
   131—Second electrical energy storage unit—capacitor or battery (End user)
   135—Generator wire (To first and second capacitors or batteries)
122—Pneumatic piston
   123—Spring (optional-located within 122)
   124—Piston
126—Air source
   111—Compressor motor or pump
   125—Air chamber
   127—Air hose
   133—Valves
   129—Relay or control module
   132—Manual action relay controllers
140—Magnetic induction generators
   141—Magnet
   142—Induction coil
   143—First spring
   146—Second spring (Optional)
   144—Transformer
   145—Metal Bar
   147—Magnetic shielding divider or wall
   170—End user

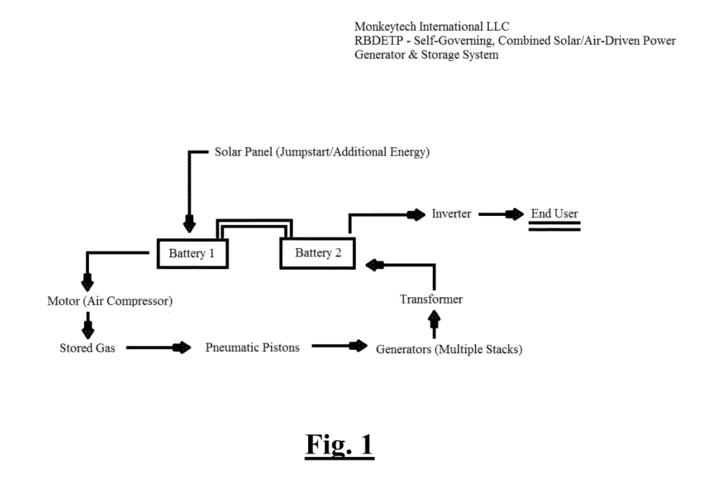

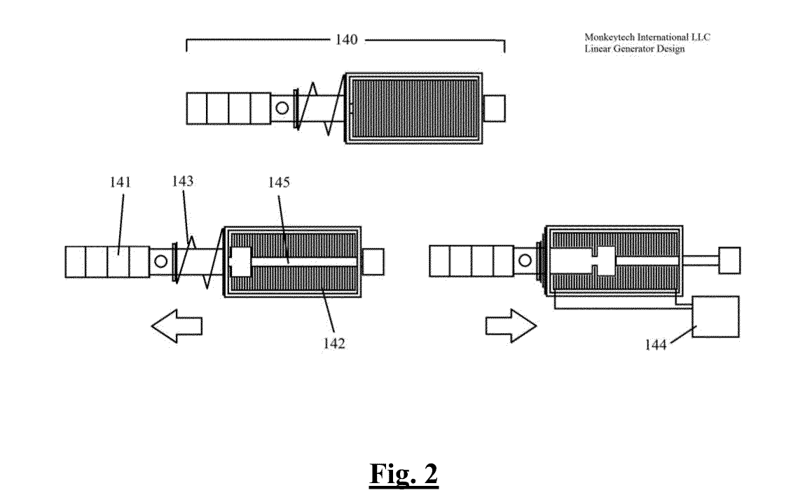

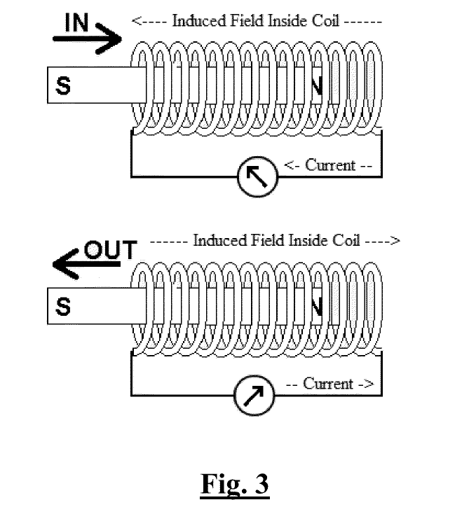

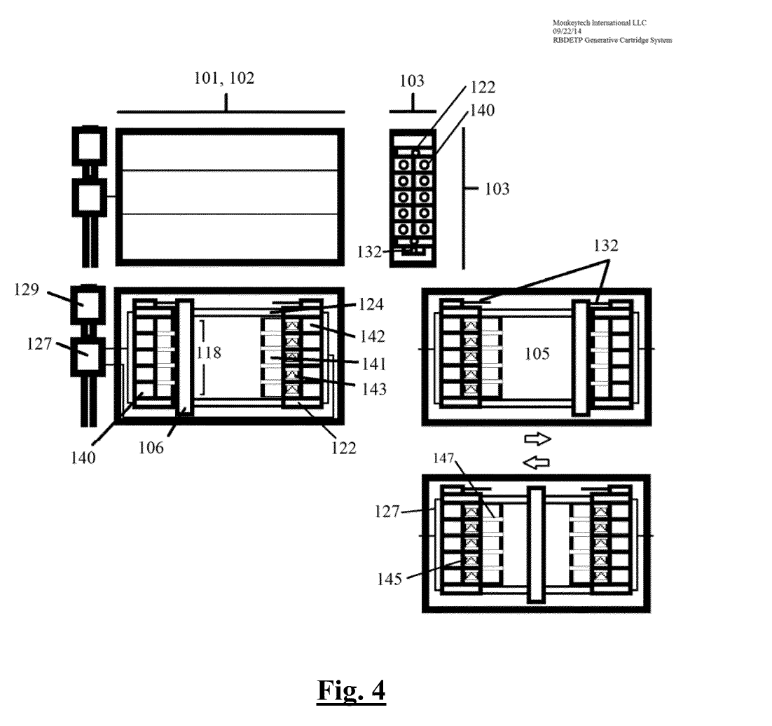

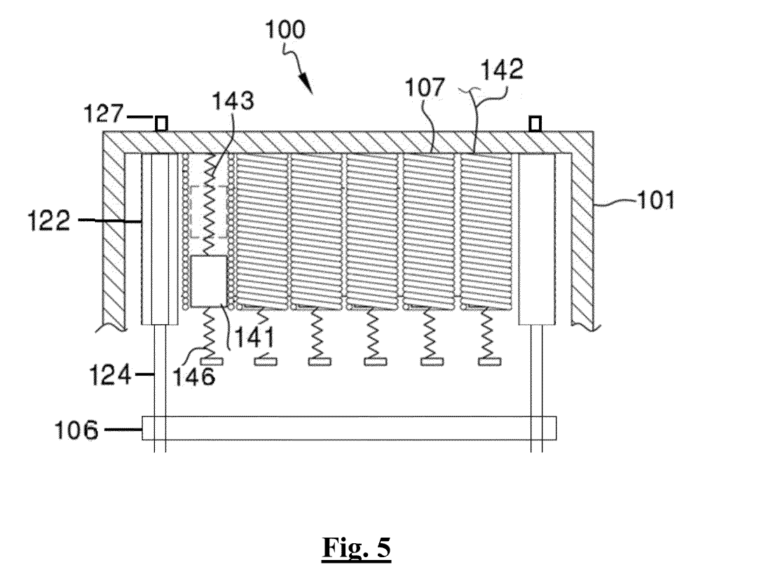

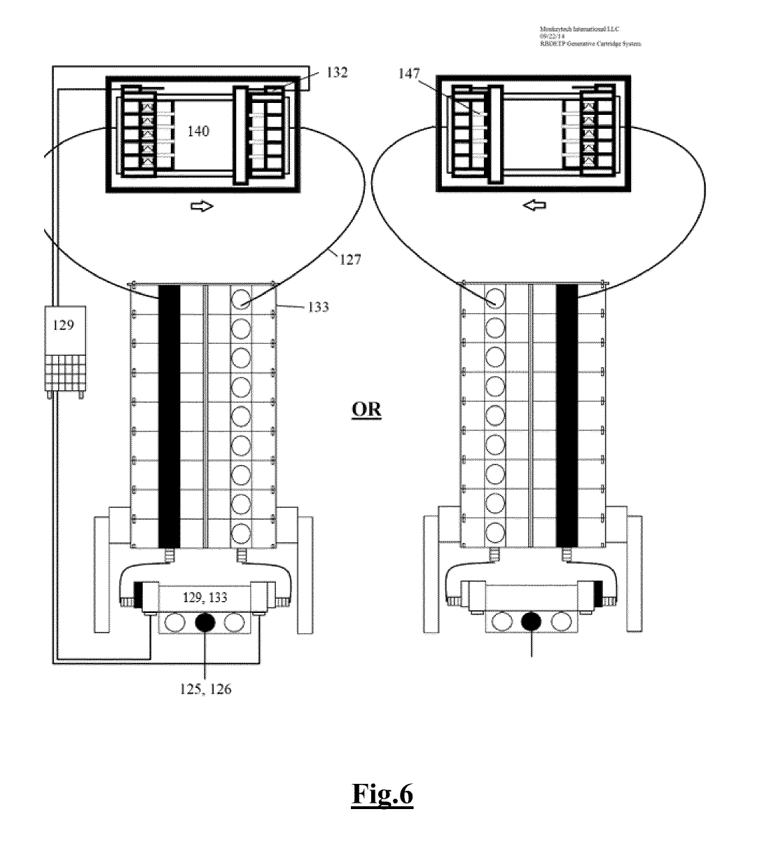

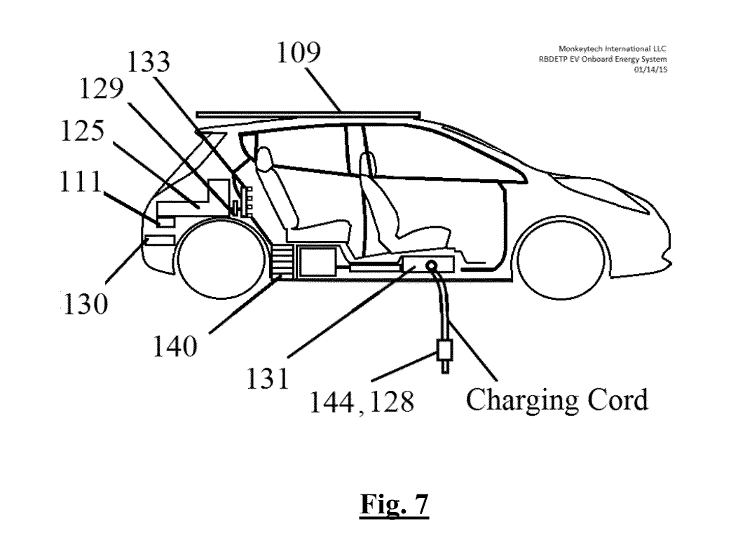

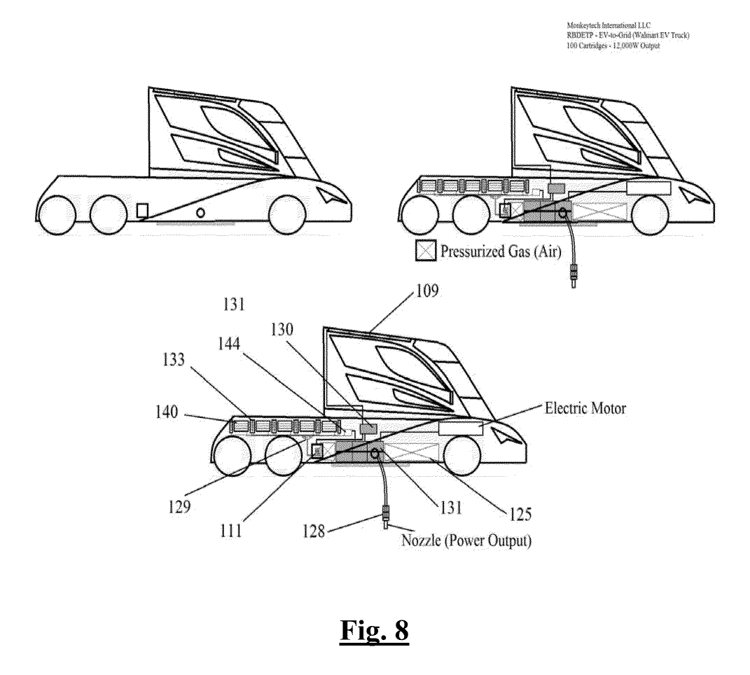

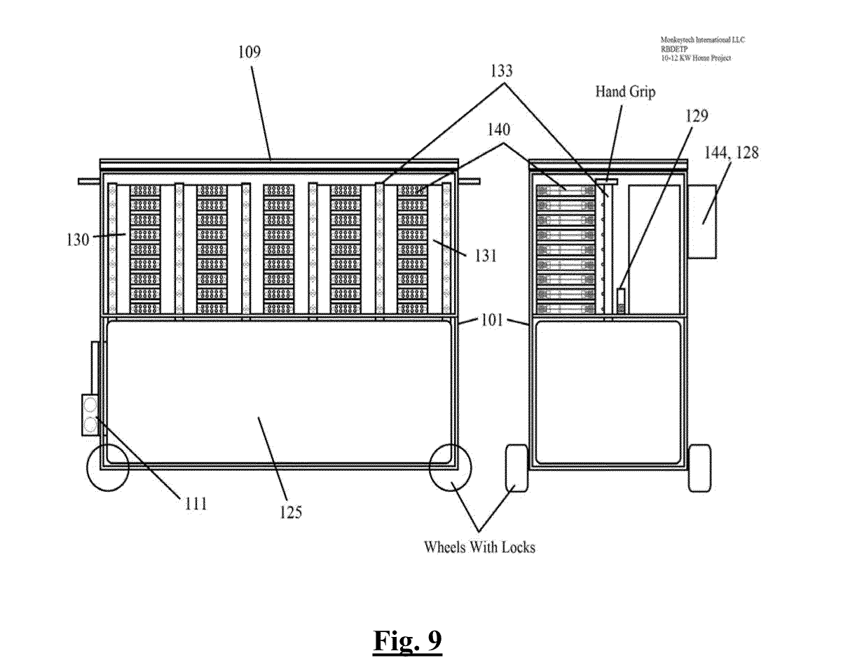

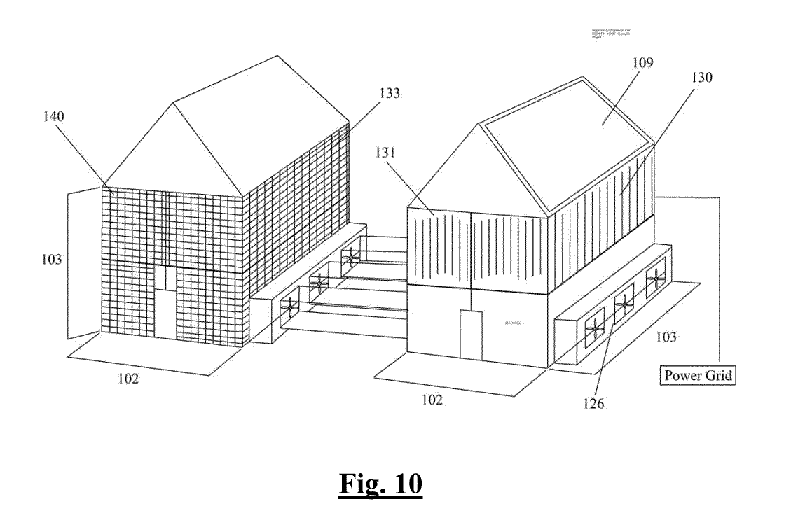

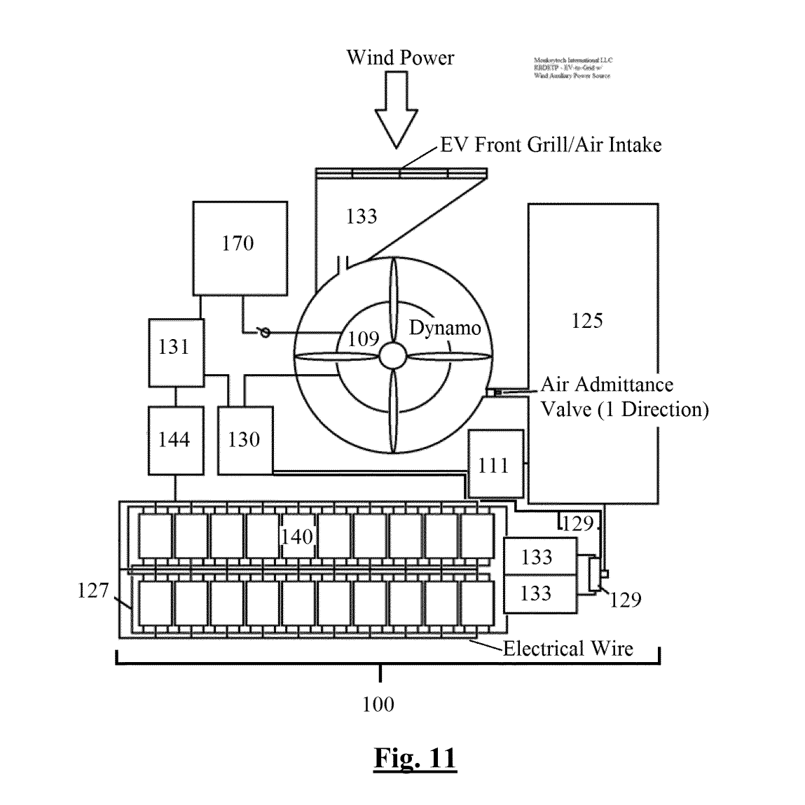

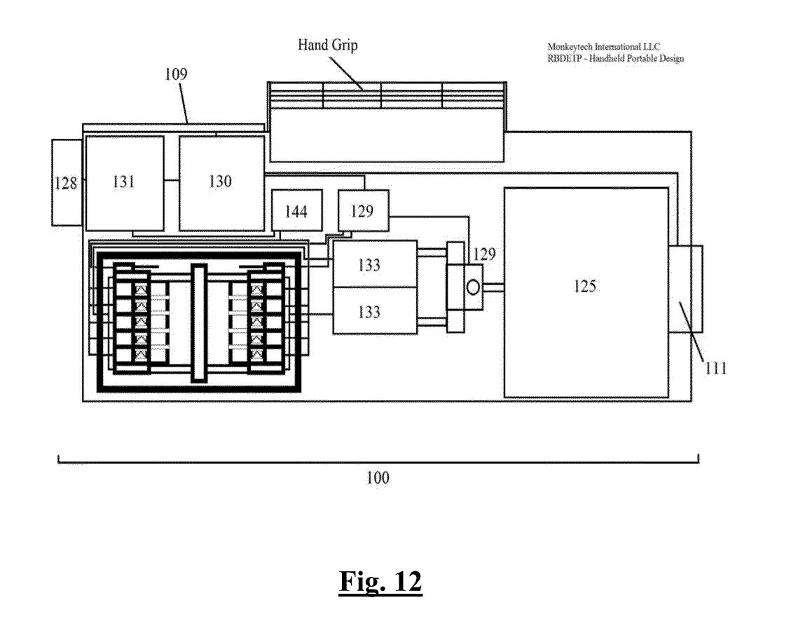

Detailed reference will now be made to a preferred embodiment of the present invention, examples of which are illustrated in FIGS. 1-12. The compressed air energy storage system comprising a rail barrel direct energy transferor piezoelectricity 100 (hereinafter “invention”) includes a housing or rail barrel 101 of an undefined length 102 and undefined internal length or width or depth 103. That being said, the housing or rail barrel 101 is of hollowed construction and includes extended side track rods 104 extending lengthwise along an inner surface 105 with which a drive shaft or bridge bar 106 that is interconnected with the extended side track rods 104 engages and traverses back and forth between distal ends 107.

The housing or rail barrel 101 includes a series of linear generators 140 at the distal ends 107, and draw kinetic energy from the drive shaft or bridge bar 106 when in contact therewith. It shall be noted that the invention 100 is designed in such a way that the drive shaft or bridge bar 106 is mobile and traverses back and forth between the distal ends 107 in order to transfer kinetic energy to the linear or magnetic induction generators 140 for electrical production when arriving at the distal ends 107 by the use of a compressed air source 126. That being said, the housing of the drive shaft or bridge bar 118 loses a portion of the kinetic force stored therein when communicated to the linear or magnetic induction generator 140; so upon contact, and upon moving away from said linear or magnetic induction generator 140 and moving towards an opposing distal end, said housing of drive shaft or bridge bar 118 is imparted new kinetic force by compressed air source 126 in order to restore the level of kinetic force therein for transference to the linear or magnetic induction generator 140 at the opposing distal end 107, etc.

The series of magnetic induction generators 140 produce electricity, which is transferred to the second electrical energy storage unit 131.

Pneumatic pistons 122 are located at each distal end 107, and work in unison with interconnected extended side track rods 104 and drive shaft or bridge bar 106 to apply applicable force to traverse the drive shaft or bridge bar 106 back and forth along the inside of the rail barrel 101. The pneumatic pistons 122 can include a spring 123 coupled with a piston 124. Regulated by a relay or control module 129, the piston 124 is connected to an air chamber 125, which supplies compressed air to all of the pistons 124 via compressed air hoses 127. The air chamber 125 is supplied compressed air from a compressed air source 126.

The magnetic induction generators 140 produce electricity by absorbing kinetic pressure by the drive shaft or bridge bar; wherein the kinetic pressure is transferred into movement of a magnet 141 back and forth inside of an induction coil 142. Each magnet 141 magnetizes a metal bar 145 that works with a first spring 143 to reset the metal bar 145 back to its original position and reciprocate the kinetic pressure. Magnets can be separated by magnetic shielding divider or wall 147 to prevent magnetic interference. The generator can include an optional second spring 146 if necessary, to assist in reciprocating the weight of the combined magnet and metal bar. The first spring 143 is located on a side of the magnet 141 opposite of the optional second spring 146. The first spring 143 connects the magnet 141 to the distal end 107 of the rail barrel 101 such that the magnet 141 can travel back and forth within the induction coil 142. The optional second spring 146 extends away from the adjacent distal end 107 of the rail barrel 101. The magnet 141 or first spring 143 is responsible for hitting against the drive shaft or bridge bar 106. It shall be noted that the magnet 141 produces electricity as it traverses back and forth inside the induction coil 142 therein.

The movement of the magnet 141 back and forth within the induction coil 142 is accomplished by virtue of the first spring 143 and the optional second spring 146 in communication between the drive shaft or bridge bar 106 and the distal end 107 of the rail barrel 101. It shall be noted that as the drive shaft or bridge bar 106 traverses back and forth inside of the rail barrel 101, the housing of the drive shaft or bridge bar 118 applies kinetic pressure to the first spring 143 to extend and retract, which causes the magnet 141 to magnetize the metal bar to move back and forth inside of the induction coil 142 thereby producing electricity each time the housing of the drive shaft or bridge bar 118 traverses to each distal end 107. The AC electricity that is produced by the linear or magnetic induction generators are converted to DC by transformers 144.

The first energy storage 130 can be interconnected with the second energy storage 130; wherein electricity produced by the magnetic induction generators 140 can be transferred by a wire 135 to supply electricity to the second electrical energy storage unit 131—capacitor and/or battery—and then an inverter 128 for end user energy conversion purposes; while the first electrical energy storage unit 130 stores energy from a portable auxiliary power source 109, namely solar or wind or power grid, to supply power to the on demand motor 111 of the compressed air source 126. That being said, the compressed air source 126 is commonly an air compressor that requires electricity in order to operate a motor 111 to facilitate the compression and storage of air, which is transferred by an air hose 127 or valve system 133 to and from the air chamber 125, which then transfers the compressed air back to the pistons 124 of the pneumatic pistons 122.

It shall be noted that each distal end 107 may include at least one pneumatic piston 122 and at least one magnetic induction generator 140.

The invention 100 may include manual action controllers 132 that are positioned at both distal ends 107 of the housing or rail barrel 101. The manual action relay controllers 132 operate manually thru piezoelectric means when force is applied to their trigger which sends a command to the relay or control module 129 that regulate the released direction of the compressed air to pneumatic pistons 122 located at each distal end.

One of skill in the compressed air energy storage (CAES) art can ascertain the essential characteristics of the instant invention: a compact portable air driven generator and storage system, the rail barrel direct energy transferor is designed to work in conjunction with external auxiliary power sources like solar or wind or power grid to generate compressed air; wherein the compressed air resource can then be utilized to apply kinetic pressure to an alignment or series of linear or magnetic induction generators to produce high energy densities and store the electricity for end users, enabling the device to function as a portable generator and power station since its design allows it to store the energies of independent renewable auxiliary energy sources and apply a fraction of the accumulated energy to generate compressed air with high volumes of pressure to trigger a series of novel generators that are standing by. In summation, the air driven generator and storage system collects renewable energies, generates electricity and stores power in all sizes, making it appropriate for multiple applications, including handheld power, home power, regional power and EV-to-grid.

The housing or rail barrel houses a drive shaft or bridge bar that uses compressed air to traverses back and forth in order to transfer kinetic pressure to linear or magnetic induction generators provided at distal ends of said rail barrel. The interior of the rail barrel is outfitted with side track rods while the distal ends include pneumatic pistons that are interconnected to the sides of the side track rods at each distal end. This design will enable the pneumatic pistons to utilize compressed gas to facilitate movement of the side track rods. A drive shaft or bridge bar is used as a bridge to interconnect one side track rod to the other. The bar allows for the two pneumatic pistons on a distal end to work in sequential unison when applying kinetic force to the linear or magnetic induction generators.

The derived electricity from the generators, along with the system's initial operational energy, which is an auxiliary power source, namely a mounted solar panel, grid sourced or wind generator, are then stored into electrical energy storage units. The pneumatic pistons being supplied compressed air from a compressed air source, which receives electricity from the first electrical energy storage unit, namely the electrical energy storage unit that receives the system's initial operational energy, which is an auxiliary power source, namely a mounted solar panel, grid sourced and/or wind generator. In return, upon activation, the pneumatic pistons utilize the compressed air to apply work to interconnected extended housing tracks and interconnected frame to traverse the drive shaft or bridge bar along the parallel or extended side track rods to the awaiting linear generators. The traversing of the drive shaft or bridge bar will continue until either the system activation switch is turned off, or the electrical energy storage units are filled to capacity or the electrical energy storage units are depleted or if the compressed air resource is depleted.

With respect to the above description, it is to be realized that the optimum dimensional relationship for the various components of the invention 100, to include variations in size, materials, shape, form, function, and the manner of operation, assembly and use, are deemed readily apparent and obvious to one skilled in the portable air driven generator and storage (e.g., compressed air energy storage (CAES)) system art, and all equivalent relationships to those illustrated in the drawings and described in the specification are intended to be encompassed by the invention 100.

It shall be noted that those skilled in the compressed air energy storage (CAES) system art will readily recognize numerous adaptations and modifications which can be made to the various embodiments of the present invention which will result in an improved invention, yet all of which will fall within the spirit and scope of the present invention as defined in the following claims. Accordingly, the invention is to be limited only by the scope of the following claims and their equivalents.

1. A compressed air energy storage (CAES) system, comprising a direct energy transference rail barrel, comprising:
a housing or rail barrel within which a drive system comprising a drive shaft or bridge bar traverses back and forth between distal ends in order to transfer kinetic force to linear or magnetic induction generators located at said distal ends;
wherein said drive shaft or bridge bar, which acts as an interconnecting force applicator, is interconnected along a pair of parallel side track rods that span between said distal ends such that when said drive shaft or bridge bar is traversing down a length of said housing or rail barrel, kinetic force is added to said drive shaft or bridge bar, which is consequentially removed when engaged against said series of respective linear or magnetic induction generators of the said respective distal end;
wherein said distal ends including a plurality of pneumatic pistons that interconnect with said parallel side track rods to traverse said drive shaft or bridge bar that interconnects said parallel side track rods back and forth to said opposing distal ends;
wherein said pneumatic pistons are provided compressed air to push said parallel side track rods that interconnect with said drive shaft or bridge bar wherein said compressed air is supplied from a compressed air source;
wherein said compressed air source receives electricity from a first electrical energy storage unit, which receives auxiliary power from said interconnected, external portable and renewable power source, namely a mounted solar panel, power grid and/or wind generator;
wherein said distal ends include a series of said linear or magnetic induction coils that produce electricity when engaged with said drive shaft or bridge bar, and AC electricity is converted to DC electricity by a transformer and then transferred to a second electrical energy storage unit;
wherein said linear or magnetic induction generators and an auxiliary power source produce electricity that can be (i) transferrable to either said first or said second electrical energy storage units, depending on energy level demand or requirement, since said first electrical energy storage unit can be interconnected to said second electrical energy storage unit, or (ii) stored to electrical storage units since the electrical storage units are interconnected;
wherein a manual or automatic activation switch is used to start the air driven generator and storage device; wherein the activation switch interconnects the first electrical energy storage unit to a relay or a control module and a motor of an air compressor unit, as well as any other device required for operational purposes.

2. The rail barrel of claim 1, wherein said housing or rail barrel is of an undefined length having an undefined inner diameter, and including said side track rods extending lengthwise along an inner surface with which said drive shaft or bridge bar engages and traverses back and forth between said distal ends; and wherein said air compressor components as well as auxiliary power source and batteries are located outside the rail barrel cartridge-style design.

3. The rail barrel of claim 2, wherein said drive shaft or bridge bar is rectangular in shape, is of undefined length and diameter, and includes a sleeve that facilitates the interconnection with the side track rods; wherein the sleeve is engaged upon the side track rods such that as the drive shaft or bridge bar goes from one distal end to another distal end.

4. The rail barrel of claim 3, wherein said drive shaft or bridge bar includes a housing that is able to freely move with respect to not only said parallel tracks rods that are located on each side of the housing or rail barrel but also said pneumatic pistons that supply pneumatic force movement.

5. The rail barrel of claim 4, wherein the housing or surface of said drive shaft or bridge bar is responsible for the engagement and transference of kinetic force to said series of linear or magnetic induction generators when in contact.

6. The rail barrel of claim 1, wherein said pneumatic pistons located at each distal end are responsible for propelling said housing of said drive shaft or bridge bar back and forth along the inside of said rail barrel through the interconnectivity between said pneumatic piston with said side track rods, which are interconnected by said drive shaft or bridge bar; wherein said pneumatic pistons each include said spring coupled with said piston; wherein said piston is connected to said air chamber, which supplies compressed air to all of said pistons using said compressed air hoses, said valves and said relay or control modules; wherein said air chamber is supplied compressed air by said motor of the compressed air source.

7. The rail barrel of claim 1, wherein said linear magnetic induction generators produce electricity upon movement of said magnet back and forth inside of said induction coil; wherein said magnets include said first spring and said optional second spring; wherein said first spring is located on a side of the magnet opposite of said optional second spring; wherein said first spring connects said magnet to said distal end of said rail barrel such that said magnet can travel back and forth within said induction coil.

8. The rail barrel of claim 7, wherein said magnet and said first spring extends away from the adjacent distal end of the rail barrel, and is responsible for hitting against said drive shaft or bridge bar wherein the movement of said magnet back and forth within said induction coil is accomplished by virtue of said first spring and said optional second spring; wherein said drive shaft or bridge bar traverses to said distal end of said rail barrel to facilitate any applied kinetic pressure associated with movement by using said housing or frame of drive shaft or bridge bar frame while traversing back and forth within the rail barrel.

9. The rail barrel of claim 8, wherein AC electricity produced by said linear magnetic induction generators when kinetic pressure is applied by said drive shaft or bridge bar housing is transferred to said transformer that converts AC to DC current; wherein electricity is then directed to said second electrical energy storage unit by wire or wirelessly.

10. The rail barrel of claim 1 wherein said compressed air source receives electricity from said first electrical energy storage unit, which receives auxiliary power from said interconnected, external portable and renewable power source, namely a mounted solar panel, wind generator or power grid.

11. The rail barrel of claim 1, wherein said manual or automatic activation switch is used to start the air driven generator and storage device; wherein the activation switch interconnects the first electrical energy storage unit to said relay or control module and said motorized pump of air compressor unit, wherein pneumatic force derived from the CAES chamber of the compressor unit triggers relay switches that are positioned at each distal end of the rail barrel to trigger pneumatic piston movement.

12. A microgrid, comprising a plurality of direct energy transference rail barrels according to claim 1; wherein said plurality of rail barrels is connected in series or parallel.

13. Compressed air energy storage (CAES) operation of said rail barrel is operated by battery 1 or electrical storage unit 1, which interconnects an auxiliary power source or grid and a motorized pump; wherein compressed air is stored within a compressed air storage chamber; wherein the rail barrel direct energy transferor piezoelectricity system utilizes the generated compressed air to apply kinetic pressure to a series of linear or magnetic induction generators to produce electrical energy; wherein storing the produced electrical energy in battery 2 or electrical energy storage unit 2; wherein battery storage 2 or electrical energy storage unit 2 can be interconnected to battery 1 or electrical energy storage unit 2 to provide electrical energy to an end user.
